(19) United States
(12) Patent Application Publication
(10) Pub. No.: US 2004/0117289 A1
(43) Pub. Date: Jun. 17, 2004

(54) System and method for monitoring and processing trades

(75) Inventors: Marion O. McNealy, Seattle, WA (US); Christopher S. Hill, Redmond, WA (US); David S. Burgett, Seattle, WA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: GE Financial Assurance Holdings, Inc., Richmond, VA (US)

(21) Appl. No.: 10/318,230

(22) Filed: Dec. 13, 2002

(51) Int. Cl. G06F 17/60

(52) U.S. Cl. 705/37; 705/4

(57) ABSTRACT

The present invention relates to a system, process and method for purchasing securities and selling insurance policies within a business entity having an internal trading system for inputting trades and an internal management system for managing trade information. According to a preferred embodiment of this aspect of the invention, a method is provided which includes: selling an insurance policy; inputting data concerning the sold insurance policy into the internal trading system; selecting a security to purchase; inputting trade data regarding the desired purchase into the internal trading system; allocating the selected security to an insurance policy sold; executing the purchase of the selected security; retrieving data regarding purchases from an external trading information system; updating and correcting errors in the trade data using the retrieved data; and storing the trade data and the insurance policy data to an internal management system.

### BACKGROUND OF THE INVENTION

The present invention relates to a system, method and process for monitoring and processing trades of securities, and more particularly, to a system and process for monitoring and processing trades of securities within a business entity which sells insurance related products.

When insurance is sold, both an asset and a liability are created. The asset exists in the form of income from the insurance policy owner. The liability exist in the coverage due under the policy when insurance claims are filed.

Because of the nature of insurance, the asset created when a policy is sold is immediately realized and the liability remains contingent on future events. Accordingly, to plan for and offset the future costs of its liabilities, insurance companies must use a combination of two key methods to keep their accounts in order. A first method is for insurance companies to re-sell their insurance liabilities to other large insurance firms. This practice is called reinsurance. A second method used in combination with reinsurance is the purchase of low risk securities to provide future income. Primarily, insurance companies invest in securities such as bonds. Using reinsurance and securities, insurance companies are able to offset and plan for their future liabilities.

For each insurance company, the balance between their liabilities and their assets are strictly monitored and are required by law to be kept in balance. Keeping this balance in accordance with state law is generally referred to as “compliance.”

For insurance companies, managing the balance between assets and liabilities is a complex burden which is handled by large and costly staffs. Complicating matters is the fact that insurance companies are heavily regulated by each state in which they do business and each state sets different rules for compliance. Further complicating matters is the fact that the balance between liabilities and assets is continually changing as insurance policies are sold and as the securities markets rise and fall.

Presently, most insurance companies rely on a variety of systems to provide them with data and reports on the state of their balance sheets. However, these systems as a whole are unable to discern and communicate the status of an insurance investment portfolio in a timely and efficient manner.

Other drawbacks may also exist.

### SUMMARY OF THE INVENTION

According to one aspect of the present invention, a method is provided for purchasing securities and selling insurance policies within a business entity having an internal trading system for inputting trades and an internal management system for managing trade information. According to a preferred embodiment of this aspect of the invention, the method includes: selling an insurance policy; inputting data concerning the sold insurance policy into the internal trading system; selecting a security to purchase; inputting trade data regarding the desired purchase into the internal trading system; allocating the selected security to an insurance policy sold; executing the purchase of the selected security; retrieving data regarding purchases from an external trading information system; updating and correcting errors in the trade data using the retrieved data; and storing the trade data and the insurance policy data in an internal management system.

According to another aspect of the present invention, a trade management system for tracking inputted trades and insurance sales information is provided. According to a preferred embodiment of this aspect of the invention, the trade management system includes: an insurance policy sales system, wherein the insurance policy sales system produces insurance policy sales data; a trade input device, wherein the trade input device accepts trade input data; a trade execution system, wherein the trade execution system executes trades using the trade input data; and an internal trading system for accepting insurance policy sales data and trade input data, wherein the internal trading system allocates inputted trades with outstanding insurance policies using the insurance policy sales data and trade input data in accordance with a predetermined compliance requirement.

According to another aspect of the present invention, a medium containing code is provided for causing a process to purchase securities and sell insurance policies within a business entity having an internal trading system for inputting trades and an internal management system for managing trade information. According to one embodiment of this aspect, the code includes: code for inputting data concerning the sold insurance policy into the internal trading system; code for selecting a security to purchase; code for inputting trade data regarding the desired purchase into the internal trading system; code for allocating the selected security to an insurance policy sold; code for executing the purchase of the selected security; code for retrieving data regarding purchases from an external trading information system; code for updating and correcting errors in the trade data using the retrieved data; and code for storing the trade data and the insurance policy data to an internal management system.

According to another aspect of the present invention, another system for purchasing securities and selling insurance policies within a business entity having an internal trading system for inputting trades and an internal management system for managing trade information is provided. According to one embodiment of this aspect, the system includes: a means for selecting a security to purchase; a means for inputting trade data regarding the desired purchase into the internal trading system; a means for allocating the selected security to an insurance policy sold; a means for executing the purchase of the selected security; a means for retrieving data regarding purchases from an external trading information system; a means for updating and correcting errors in the trade data using the retrieved data; and a means for storing the trade data and the insurance policy data in an internal management system.

Other advantages and exemplary embodiments are also included in the present application

### BRIEF DESCRIPTION OF THE FIGURES

FIG. 1 is a flowchart illustrating a method according to an embodiment of the present invention.

FIG. 2 is a flowchart illustrating a method according to an embodiment of the invention.

FIG. 3 is a flowchart illustrating a method according to an embodiment of the invention.

FIG. 4 is a flowchart illustrating a method according to an embodiment of the invention.

FIG. 5 is schematic diagram illustrating a system according to an embodiment of the invention.

### DETAILED DESCRIPTION OF THE INVENTION

Reference will now be made in detail to the present preferred embodiments of the invention, examples of which are illustrated in the accompanying drawings in which like reference characters refer to corresponding elements.

The present invention is related to a system and method for monitoring and processing trades of securities within a business entity which sells insurance related products. Reference will be made to internal and external elements for receiving and producing trade data. More specifically, reference will be made to a series of steps to be performed within an organization, comprising several different entities, and at least one external agency, for receiving, producing and analyzing data. The present invention should not be construed as limited to the organization structure shown which is provided purely for example. Further, for each step and series of steps, it should be understood that no order for the steps is required in the present invention.

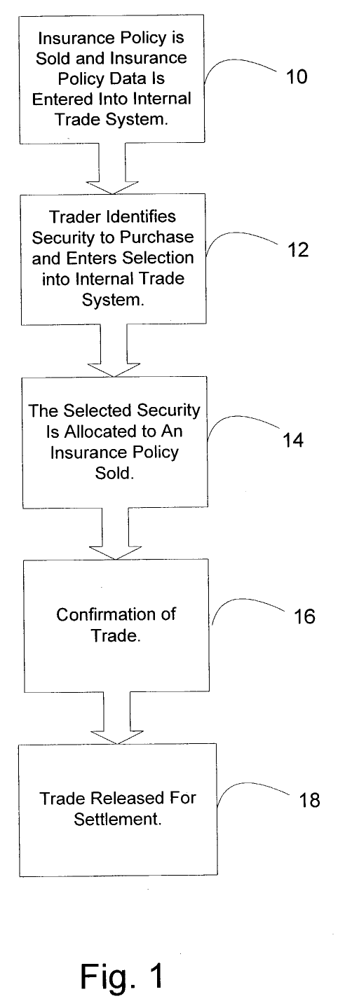

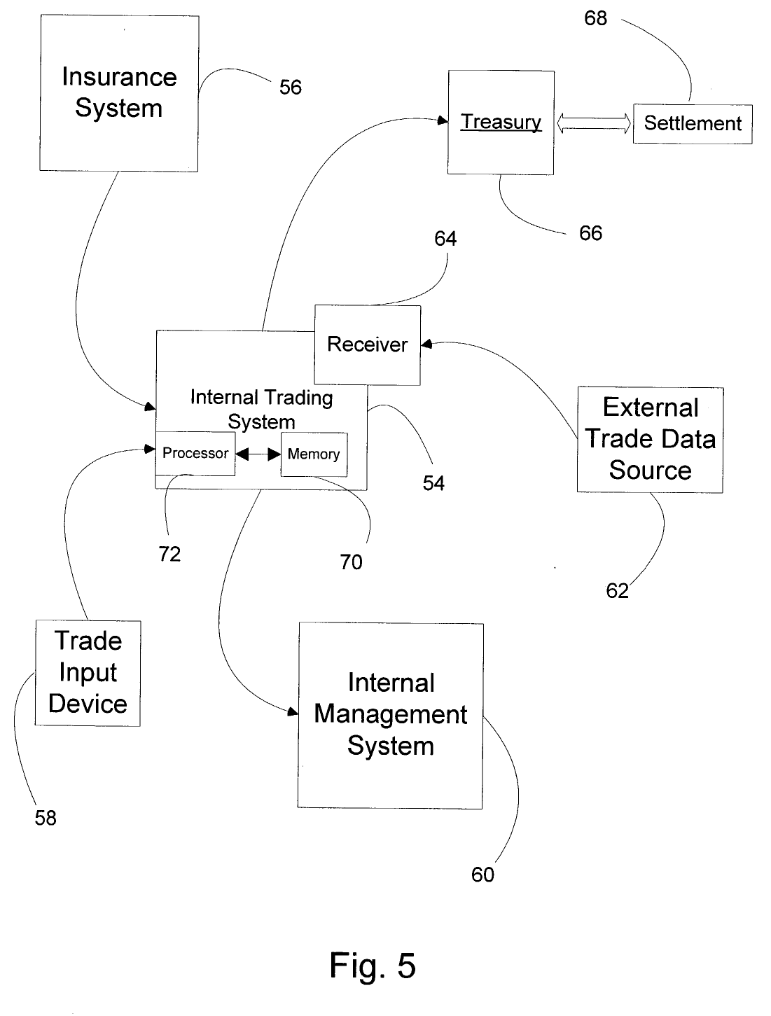

FIG. 1 is a flowchart illustrating a first series of steps to monitor and process trades of securities according to one embodiment of the present invention. FIG. 5 is a schematic diagram illustrating the elements of FIG. 1. At step 10, an insurance policy is sold within an insurance sales system 56 and insurance policy data is entered or made available to the internal trade system 54. The type of insurance sold may include any type of insurance which can be bought and sold. For example, the types of insurance may include annuities, life insurance, term life, longer term care insurance, whole life, universal life, variable life, automobile insurance, automobile warranties as well as others. Further, the means for selling the insurance policy may include any type of mechanism which allows insurance policies to be bought and sold. This may include, for example, a sale conducted in person, a sale via an insurance agent, a sale made via telephone, or an on-line purchase of insurance.

Naturally, because of the nature of insurance sales and the variety of types of sales made, the time between the sale of an insurance policy and the uploading of the policy data onto an internal trade system 54 may be separated by some time. In particular, the collection, processing and entry of insurance policy data may understandably be delayed depending on the internal procedures of the companies involved. During this process, individual or multiple policies may be grouped together so that insurance policy data from multiple policies or insurance entities is combined prior to being forwarded to the internal trading system 54. Once this data is forwarded, the internal trading system 54 is able to processes and store the insurance policy data and determined the compliance requirements which apply.

At step 12, a trader selects and identifies the appropriate securities to purchase. This selection is usually based on market conditions, the makeup of the outstanding policies of the insurance company as well as the present balance of the insurance company's investment portfolio. Additionally, multiple traders may be performing trades in a variety of locations. Further, the traders may work directly for the insurance company or they may be commissioned to perform trades on behalf of the insurance company. The type of securities purchased may include any type of securities which may be bought or sold. For example, the securities purchased may include, for example, stocks, bonds, derivatives, mortgage bonds, asset based securities and other types of securities as well.

Regardless of the specific trading arrangement and the type of securities identified for purchase, once a trade is proposed by the trader, the proposed trade data is entered into the internal trade system 54. As shown in FIG. 5, the trade data may be entered via a trade input device 58. Alternatively, this data may simply be made available to the internal trade system via the Internet or other network arrangement.

At step 14, the internal trade system 54 compares the insurance policy data submitted with the proposed trade data. The internal trade system then allocates or matches the value between the insurance policies issued and the security proposed for purchase. This allocation is preferably performed so as to satisfy the compliance and investment requirements for each jurisdiction relevant for compliance. According to a preferred embodiment, the approved value of securities to be purchased will be such that the future income from the securities will be equal to or greater than a selected percentage of the outstanding liabilities of the insurance policies sold.

Once a determined value of securities is approved for purchase, the processor 72 may generate a confirmation code and, at step 16, the confirmation code confirming the trade may be provided to the trader. With this confirmation received, the trade, at step 18, may then be released for settlement. As shown in FIG. 5, the trade may be released to a corporate treasury department 66 for settlement 68.

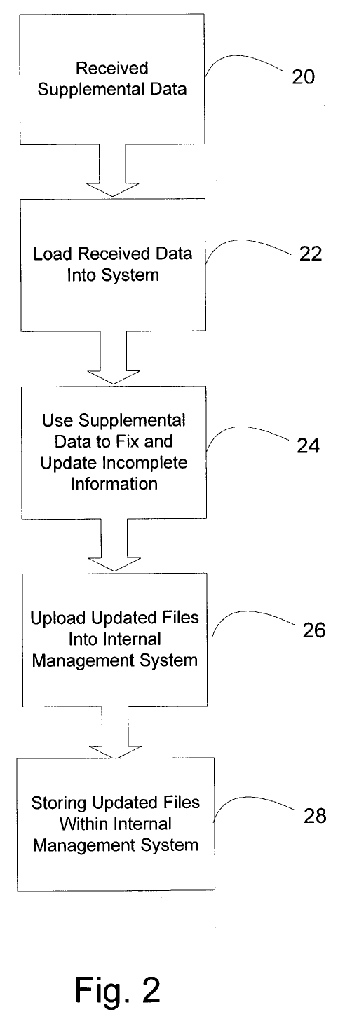

With reference to FIG. 2, the post-settlement processes of the present invention will now be discussed. In step 20, following the execution of a trade, supplemental data is preferably received from an external trade data source 62 which may be a system such as Bloomberg's or a similar reporting system. In step 22, the received data may be loaded into the internal trading system 54 after being received by receiver 64. In an alternative embodiment, the received data may be loaded onto any system containing trade data to be updated and corrected.

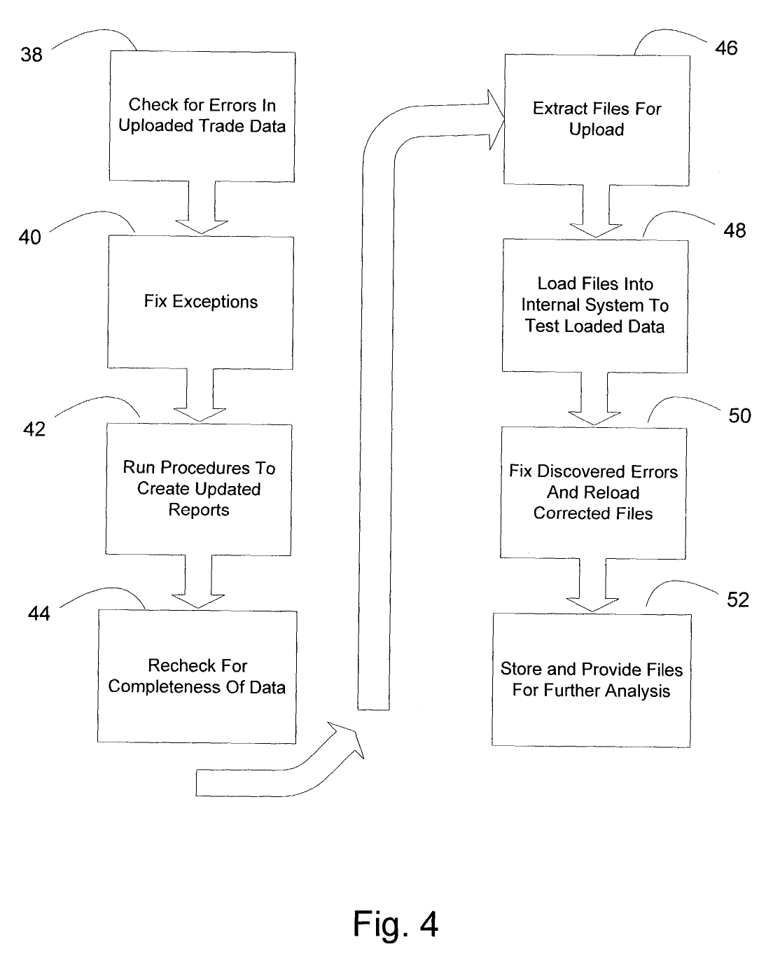

In step 24, the supplemental data may be used by the processor 72 to fix and update incomplete trade information stored in memory 70 within the internal trading system 54. In accordance with a first preferred embodiment, the process of fixing and updating trade information may be performed in accordance with the method described with reference to FIG. 4 below. Alternatively, this process may be performed using an automated process to identify and supply missing data where necessary. In step 26, the updated files may be uploaded or made available to at least one other internal management system 60. In step 28, the updated files may be stored in memory 70.

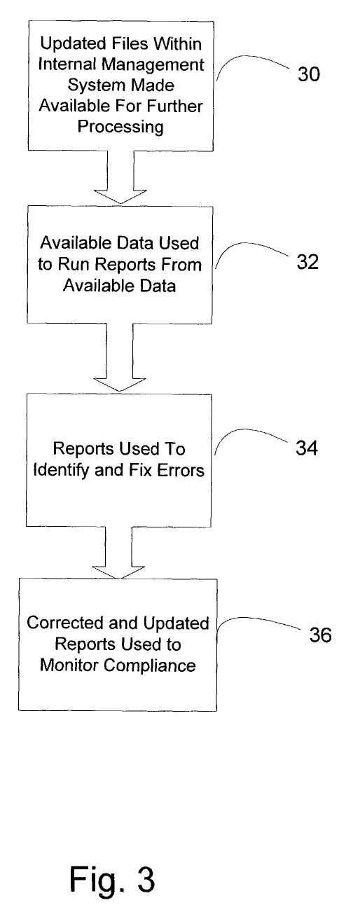

With reference to FIG. 3, at step 30 the updated and stored files may be made available for further processing within at least one other internal management system. At step 32, the updated files may be used to create and run reports using the updated trade data. At step 34, the reports may be used to further identify and fix errors and omissions within the updated trade data. At step 36, the update reports may be made available to further monitor and document compliance.

With reference to FIG. 4 a preferred method for updating and correcting errors within trade data as called for in step 34 is provided. In step 38, the updated files within the internal management system 60 are checked for errors such as missing or incomplete fields. This process may occur manually or via a software process. In step 40, the missing fields and other found errors are fixed. In step 42, updated reports may be run. In step 44, the updated reports may be rechecked for completeness and accuracy. Assuming the updated reports are satisfactory, in step 46 the data files may be extracted for upload. In step 48, the extracted files may be loaded into a test system to ensure accuracy and completeness. In step 50, the loading errors may be fixed and the files may be reloaded onto the system. In step 52, the files may be stored and made available to the internal management system 60 for producing reports used to monitor compliance. The methods and processes of FIGS. 1-4 will now be described in greater detail below, with reference to FIG. 5.

As discussed above, the system and method of present invention are designed for use by a business entity which sells insurance policies for which securities must be purchased to offset the amount of future liabilities. As shown in FIG. 5, within insurance system 56, insurance policy data is produced and forwarded to a centralized internal trading system 54. As discussed above, this insurance policy data may be produced from a variety of sources (e.g. individual policies, groups of policies, entire insurance policy portfolios.) As further discussed above, this insurance policy data my relate to any type of insurance which may be bought or sold (e.g. annuities, life insurance, term life, longer term care insurance, whole life, universal life, variable life, automobile insurance, and automobile warranties). As with insurance policy data, trade data is also provided to the internal trading system 54. Trade data may be provided using at least one trade input device 58.

With the inputted trade data and insurance policy data, the internal trading system 54 processes and allocates proposed trades entered into the trade input system so that they correspond to a specific amount of liability incurred by outstanding insurance policies. Where the internal trading system 54 is able to match the amount of the proposed trade with an outstanding liability, the internal trading system 54 approves the trades for execution. Once approved, the internal trading system then forwards the trade and notice of approval to the corporate treasury 66 for settlement 68. Following execution of the trade, the internal trading system 54 records details of the trade in memory 70.

Initially, the trade data which is recorded in the internal trading system 54 is incomplete. According to a preferred embodiment of the present invention, the trade data may be later updated with additional trade data may occur from at least one external trade data source 62 via receiver element 64. In accordance with a preferred embodiment of the present invention, the updating of the trade data using data from an external data source such as Bloomberg's or similar trade information service. Alternatively, any entity producing trade data may be used. Further in accordance with a preferred embodiment of the present invention, such trade data may be provided via a dedicated network connection. Alternatively, such trade data may be provided via an Internet, LAN, W-LAN or other similar connection.

With the additional trade data, the internal trading system 54 may update and fix errors in its originally collected trading data. Thereafter, the updated trade data may be provided to at least one internal management system 60 for further processing and analysis. According to a preferred embodiment of the present invention, the updated trade data may be further provided to an accounting system produced by SS&C (i.e. the CAMRA™ system) or similar system for analysis.

According to a preferred embodiment, the internal trading system may include an application server and web server for processing trade input data, insurance policy data and other data and for communicating with internal and external processors. The servers used may include a Sun E450 server. Further, a web server layer may be used, such as iPlanet. An operating system module may also be used for running portions of the internal trading system 54 and for enabling other functions and features to be performed as necessary. According to an embodiment of the invention, the operating system module may use a UNIX based operating system, such as Solaris. Alternatively, the operation system module may use another type of operating system such as a Windows or Apple based operating system.

Further in accordance with the present invention, the internal trading system 54 and particularly memory 70, may include a database. According to a preferred embodiment, the database may use a server running Microsoft SQL server software. Alternatively, any other database software such as Oracle or other Microsoft database software may be used.

According to another embodiment of the invention, a computer-usable and writeable medium having a plurality of computer readable program code stored therein may be provided for practicing the process of the present invention. The process and system of the present invention may be implemented within a variety of operating systems, such as a Windows operating system, various versions of a Unix-based operating system (e.g., a Hewlett Packard, a Red Hat, or a Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of a system may comprise computer readable program code in the form of functional instructions stored in the computer-usable medium such that when the computer-usable medium is installed on the system, those components cause the system to perform the functions described. The computer readable program code for the present invention may also be bundled with other computer readable program software.

According to one embodiment, the internal trade system 54, processor 72, memory 70, receiver 64, and internal management system 60 may each comprise computer-readable code that, when installed on a computer, performs the functions described above. Also, only some of the components may be provided in computer-readable code.

Additionally, various entities and combinations of entities may employ a computer to implement the components performing the above-described functions. According to an embodiment of the invention, the computer may be a standard computer comprising an input device, an output device, a processor device, and a data storage device. According to other embodiments of the invention, various components may be computers in different departments within the same corporation or entity. Other computer configurations may also be used. According to another embodiment of the invention, various components may be separate entities such as corporations or limited liability companies. Other embodiments, in compliance with applicable laws and regulations, may also be used.

According to one specific embodiment of the present invention, the system may comprise components of a software system. The system may operate on a network and may be connected to other systems sharing a common database. Other hardware arrangements may also be provided.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

In the claims:

1. A method of purchasing securities and selling insurance policies within a business entity having an internal trading system for inputting trades and an internal management system for managing trade information, said method comprising:
selling an insurance policy;
inputting data concerning the sold insurance policy into the internal trading system;
selecting a security to purchase;
inputting trade data regarding the desired purchase into the internal trading system;
allocating the selected security to an insurance policy sold;
executing the purchase of the selected security;
retrieving data regarding purchases from an external trading information system;
updating and correcting errors in the trade data using the retrieved data; and
storing the trade data and the insurance policy data to an internal management system.

2. The method of claim 1, wherein the types of insurance policies sold include at least one type of policy selected from the group comprising: annuities, life insurance, term life, longer term care insurance, whole life, universal life, variable life, automobile insurance, and automobile warranties.

3. The method of claim 1, wherein the types of data updated using the retrieved data include at least one type of data selected from the group comprising: trade execution date, parties to the trade; amount of the trade, type of security purchased, broker executing trade, and code confirming trade.

4. The method of claim 1, wherein the types of securities selected for purchase include at least one type of security selected from the group comprising: stocks, bonds, derivatives, mortgage bonds, and asset based securities.

5. The method of claim 4, wherein the type of securities selected for purchase include bonds.

6. The method of claim 5, wherein the internal trading system is comprised of a processing element, a receiving element and a storage element.

7. The method of claim 6, wherein the future income value of the securities purchased is equal to or greater than a selected percentage of the outstanding liabilities of the insurance policies sold.

8. The method of claim 7, wherein the trade is executed by an external broker.

9. The method of claim 8, wherein the method further comprises the step of having the external broker forward a confirmation of the execution of the trade back to the business entity.

10. The method of claim 9, wherein the method further comprises the following steps:
receiving confirmation of the trade at the business entity; and
forwarding confirmation to the corporate treasury for settlement of the confirmed trade.

11. The method of claim 10, wherein the external data is provided via a Bloomberg trading system.

12. The method of claim 11, wherein the external data is provided via BBLink.

13. The method of claim 12, wherein the external data is stored in a database.

14. The method of claim 13, wherein the method further comprises the step of providing the trade data and insurance policy data to an additional processor for further analysis and presentation.

15. A trade management system for tracking inputted trades and insurance sales information, said trade management system comprising:
an insurance policy sales system, wherein the insurance policy sales system produces insurance policy sales data;
a trade input device, wherein the trade input device accepts trade input data;
a trade execution system, wherein the trade execution system executes trades using the trade input data; and
an internal trading system for accepting insurance policy sales data and trade input data; wherein the internal trading system allocates inputted trades with outstanding insurance policies using the insurance policy sales data and trade input data in accordance with a predetermined compliance requirement.

16. The trade management system of claim 15, wherein the trade management system uses the external trade data to update and correct errors within its trade input data.

17. The trade management system of claim 16, wherein the trade management system further comprises at least one trade analysis system, wherein data compiled and stored in the internal trading system is processed and forwarded to the trade analysis system for further analysis and presentation.

18. The system of claim 15, wherein the insurance policy sales data includes data for at least one type of policy selected from the group comprising: annuities, life insurance, term life, longer term care insurance, whole life, universal life, variable life, automobile insurance, and automobile warranties.

19. The system of claim 15, wherein the trade input data comprises at least one type of data selected from the group comprising: trade execution date, parties to the trade; amount of the trade, type of security purchased, broker executing trade, and code confirming trade.

20. The system of claim 15, wherein the types of securities traded include at least one type of security selected from the group comprising: stocks, bonds, derivatives, mortgage bonds, and asset based securities.

21. The system of claim 20, wherein the type of securities traded include bonds.

22. The system of claim 15, wherein the internal trading system is comprised of a processing element, a receiving element and a storage element.

23. The system of claim 15, wherein the internal trading system allocates the inputted trades so that the future income value of the securities purchased is equal to or greater than a predetermined compliance requirement for the amount of outstanding insurance policies enforce.

24. The system of claim 23, wherein the trade is executed by an external broker.

25. The system of claim 24, wherein the system further comprises an external trading system for executing trades, wherein the external trading system executes trades and forwards confirmation of the execution of the trade back to the trade management system.

26. The system of claim 25, wherein external trade data is provided via a Bloomberg trading system.

27. The system of claim 26, wherein external trade data is provided via BBLink.

28. The system of claim 27, wherein external trade data is stored in a database.

29. A medium containing code for causing a process to purchase securities and sell insurance policies within a business entity having an internal trading system for inputting trades and an internal management system for managing trade information, comprising:
code for inputting data concerning the sold insurance policy into the internal trading system;
code for selecting a security to purchase;
code for inputting trade data regarding the desired purchase into the internal trading system;
code for allocating the selected security to an insurance policy sold;
code executing the purchase of the selected security;
code retrieving data regarding purchases from an external trading information system;
code for updating and correcting errors in the trade data using the retrieved data; and
code for storing the trade data and the insurance policy data to an internal management system.

30. The medium containing code of claim 29, wherein the types of insurance policies sold include at least one type of policy selected from the group comprising: annuities, life insurance, term life, longer term care insurance, whole life, universal life, variable life, automobile insurance, and automobile warranties.

31. The medium containing code of claim 30, wherein the types of data updated using the retrieved data include at least one type of data selected from the group comprising: trade execution date, parties to the trade; amount of the trade, type of security purchased, broker executing trade, and code confirming trade.

32. The medium containing code of claim 29, wherein the types of securities selected for purchase include at least one type of security selected from the group comprising: stocks, bonds, derivatives, mortgage bonds, and asset based securities.

33. The medium containing code of claim 29, wherein the type of securities selected for purchase include bonds.

34. The medium containing code of claim 29, wherein the code contains instructions for communicating with a processing element, a receiving element and a storage element within the internal trading system.

35. The medium containing code of claim 29, wherein the code further contains instructions for providing that the future income value of the securities purchased is equal to or greater than a predetermined proportion of the outstanding liabilities of the insurance policies sold.

36. The medium containing code of claim 35, wherein the code further contains instructions for having an external broker for executing a trade.

37. The medium containing code of claim 36, wherein the code further comprises:
code for receiving confirmation of the trade at the business entity; and
code for forwarding confirmation to a corporate treasury for settlement of the confirmed trade.

38. The medium containing code of claim 37, wherein the medium further contains code for instructing that the external data is provided via a Bloomberg trading system.

39. The medium containing code of claim 38, wherein the medium further contains code for instructing that the external data is provided via BBLink.

40. The medium containing code of claim 39, wherein the medium further contains code for instructing that the external data is stored in a database.

41. The medium containing code of claim 40, wherein the medium further contains code for providing the trade data and insurance policy data to an additional processor for further analysis and presentation.

42. A system for purchasing securities and selling insurance policies within a business entity having an internal trading system for inputting trades and an internal management system for managing trade information, said method comprising:
a means for inputting data concerning the sold insurance policy into the internal trading system;
a means for selecting a security to purchase;
a means for inputting trade data regarding the desired purchase into the internal trading system;
a means for allocating the selected security to an insurance policy sold;
a means for executing the purchase of the selected security;
a means for retrieving data regarding purchases from an external trading information system;
a means for updating and correcting errors in the trade data using the retrieved data; and
a means for storing the trade data and the insurance policy data to an internal management system.

43. The system of claim 42, wherein the types of insurance policies sold include at least one type of policy selected from the group comprising: annuities, life insurance, term life, longer term care insurance, whole life, universal life, variable life, automobile insurance, and automobile warranties.

44. The system of claim 43, wherein the types of data updated using the retrieved data include at least one type of data selected from the group comprising: trade execution date, parties to the trade; amount of the trade, type of security purchased, broker executing trade, and code confirming trade.

45. The system of claim 44 wherein the types of securities selected for purchase include at least one type of security selected from the group comprising: stocks, bonds, derivatives, mortgage bonds, and asset based securities.

46. The system of claim 45, wherein the type of securities selected for purchase include bonds.

47. The system of claim 46, wherein the internal trading system is comprised of a processing means, a receiving means and a storage means.

48. The system of claim 47, wherein the future income value of the securities purchased is equal to or greater than a predetermined proportion of the outstanding liabilities of the insurance policies sold.

49. The system of claim 48, wherein the trade is executed by an external broker.

50. The system of claim 49, wherein the method further comprises the step of having the external broker forward a confirmation of the execution of the trade back to the business entity.

51. The system of claim 50, wherein the method further comprises:
a means for receiving confirmation of the trade at the business entity; and
a means for forwarding confirmation to the corporate treasury for settlement of the confirmed trade.

52. The system of claim 51, wherein the external data is provided via a Bloomberg trading system.

53. The system of claim 52, wherein the external data is provided via BBLink.

54. The system of claim 53, wherein the external data is stored in a database.

55. The system of claim 54, wherein the method further comprises a means for providing the trade data and insurance policy data to an additional processor for further analysis and presentation.

56. A trade management system for tracking inputted trades and insurance sales information, said trade management system comprising:
a means for producing insurance policy sales data;
a means for producing trade input data;
a means for receiving and storing trade input data and insurance policy sales data;
a trade execution means for executing trades using the trade input data; and
a means for allocating inputted trades with outstanding insurance policies using the insurance policy sales data and trade input data in accordance with a predetermined compliance requirement.

57. The trade management system of claim 56, wherein the trade management system uses the external trade data to update and correct errors within its trade input data.

58. The trade management system of claim 57, wherein the trade management system further comprises at least one trade analysis system, wherein data compiled and stored in the internal trading system is processed and forwarded to the trade analysis system for further analysis and presentation.

59. The system of claim 58, wherein the insurance policy sales data includes data for at least one type of policy selected from the group comprising: annuities, life insurance, term life, longer term care insurance, whole life, universal life, variable life, automobile insurance, and automobile warranties.

60. The system of claim 59, wherein the trade input data comprises at least one type of data selected from the group comprising: trade execution date, parties to the trade; amount of the trade, type of security purchased, broker executing trade, and code confirming trade.

61. The system of claim 60, wherein the types of securities traded include at least one type of security selected from the group comprising: stocks, bonds, derivatives, mortgage bonds, and asset based securities.

62. The system of claim 61, wherein the type of securities traded include bonds.

63. The system of claim 61, wherein the internal trading system is comprised of a processing element, a receiving element and a storage element.

64. The system of claim 63, wherein the internal trading system allocates the inputted trades so that the future income value of the securities purchased is equal to or greater than a predetermined compliance requirement for the amount of outstanding insurance policies enforce.

65. The system of claim 64, wherein the trade is executed by an external broker.

66. The system of claim 65, wherein the system further comprises an external trading system for executing trades, wherein the external trading system executes trades and forwards confirmation of the execution of the trade back to the trade management system.

67. The system of claim 66, wherein external trade data is provided via a Bloomberg trading system.

68. The system of claim 67, wherein external trade data is provided via BBLink.

69. The system of claim 68, wherein external trade data is stored in a database.
